(19) United States
(12) Patent Application Publication
(10) Pub. No.: US 2018/0285139 A1
(43) Pub. Date: Oct. 4, 2018

(54) HYPERVISOR-BASED CONTAINERS

(71) Applicant: vEyE Security Ltd., Tel-Aviv (IL)

(72) Inventors: Yuri Shapira, Tel-Aviv (IL); Yevgeniy Kulakov, Tel-Aviv (IL)

(21) Appl. No.: 15/675,746

(22) Filed: Aug. 13, 2017

Related U.S. Application Data
(60) Provisional application No. 62/480,464, filed on Apr. 2, 2017.

(51) Int. Cl. G06F 9/455

(52) U.S. Cl. CPC G06F 9/45558; G06F 2009/45591

(57) ABSTRACT

There is provided a method of creating a virtual machine (VM)-container guest operating system (OS) image for executing a container within a virtual machine started from above guest OS image, comprising: assembling a VM-container guest OS image based on: (i) a kernel image of a host OS currently running on a host computing device hosting the virtual machine, (ii) predefined kernel modules of the host OS that support virtualized hardware on the host computing device, (iii) host userspace applications for executing the container within the virtual machine, created from VM-container guest OS image, running on the host computing device, and (iv) container code constructions that set-up at least one of the virtual machine and the assembled VM-container guest OS image, for running of the container within the virtual machine, and executing the container within the virtual machine based on the assembled VM-container guest OS image.

### RELATED APPLICATIONS

This application claims the benefit of priority under 35 USC § 119(e) of U.S. Provisional Patent Application No. 62/480,464, filed on Apr. 2, 2017. The contents of the above application are all incorporated by reference as if fully set forth herein in their entirety.

### FIELD AND BACKGROUND OF THE INVENTION

The present invention, in some embodiments thereof, relates to virtualization and, more specifically, but not exclusively, to hypervisor-based containers.

A hypervisor is a computer software, firmware, or hardware that creates and runs virtual machines over a host machine. The hypervisor presents the guest operating system of the virtual machine with a virtual operating platform. Multiple instances of operating systems share virtualized hardware resources, and may be executed on a single physical computing device.

Containers share a single kernel of the host operating system and run on different computing devices, which may be physical and/or virtual. The operating system (OS) container engine component loads container image and container runtime component starts the container based on that image.

### SUMMARY OF THE INVENTION

According to a first aspect, a method of creating a virtual machine (VM)-container guest operating system (OS) image for executing a container within a virtual machine started from above guest OS image, comprises: assembling a VM-container guest OS image based on: (i) a kernel image of a host OS currently running on a host computing device hosting the virtual machine, (ii) a plurality of predefined kernel modules of the host OS that support virtualized hardware on the host computing device, (iii) a plurality of host userspace applications for executing the container within the virtual machine, created from VM-container guest OS image, running on the host computing device, and (iv) container code constructions that set-up at least one of the virtual machine and the assembled VM-container guest OS image, for running of the container within the virtual machine, and executing the container within the virtual machine based on the assembled VM-container guest OS image.

According to a second aspect, a system for creating a virtual machine (VM)-container guest operating system (OS) image for executing a container within a virtual machine started from above guest OS image, comprises: a non-transitory memory having stored thereon a code for execution by at least one hardware processor of a host computing device, the code comprising: code for assembling a VM-container guest OS image based on: (i) a kernel image of a host OS currently running on a host computing device hosting the virtual machine, (ii) a plurality of predefined kernel modules of the host OS that support virtualized hardware on the host computing device, (iii) a plurality of host userspace applications for executing the container within the virtual machine, created from VM-container guest OS image, running on the host computing device, and (iv) container code constructions that set-up at least one of the virtual machine and the assembled VM-container guest OS image, for running of the container within the virtual machine, and code for executing the container within the virtual machine based on the assembled VM-container guest OS image.

According to a third aspect, a computer program product for creating a virtual machine (VM)-container guest operating system (OS) image for executing a container within a virtual machine started from above guest OS image, comprises: a non-transitory memory having stored thereon a code for execution by at least one hardware processor of a host computing device, the code comprising: instructions for assembling a VM-container guest OS image based on: (i) a kernel image of a host OS currently running on a host computing device hosting the virtual machine, (ii) a plurality of predefined kernel modules of the host OS that support virtualized hardware on the host computing device, (iii) a plurality of host userspace applications for executing the container within the virtual machine, created from VM-container guest OS image, running on the host computing device, and (iv) container code constructions that set-up at least one of the virtual machine and the assembled VM-container guest OS image, for running of the container within the virtual machine, and code for executing the container within the virtual machine based on the assembled VM-container guest OS image.

The systems, methods, and/or code instructions described herein address the technical problem(s) that arise when hypervisor-based containers are implemented. The addressed technical problem is related to security, optionally network security, in particular, to the problem of container escape and tenancy separation.

Moreover, existing hypervisor-based container runtime environments generally based on guest OS image which includes custom kernel and custom usermode components that execute the VM and run the container within the VM. Such guest OS components are distinct from the host OS executing on the host computing device on which the hypervisor is executing. The customized kernel and/or customized usermode components of the guest OS image, which are independent/different of/from the host OS running on the computing device, may be created by a third party entity, which is external and independent to the entity managing the host computing device on which the hypervisor is executed. The customized kernel and/or customized usermode components may present a security risk, and/or may be frequently updated, for example to correct errors, add new features, and fix security risks. The technical problem that arises is related to the overhead incurred during updating of the custom kernel and usermode components. Generally, the runtime external third party vendor performs the update of the custom kernel and customer usermode components. Significant overhead is incurred, and/or a security risk is formed during the gap between when the third party performs the update, and when the update is implemented within the host computing system.

The systems, methods, and/or code instructions described herein improve computational performance of the host computing device executing hypervisor-based containers. The computational performance of the host computing device is improved by the systems, methods, and/or code instructions described herein for assembling the VM-container guest OS image based on the host OS components, rather than based on custom OS components and/or other custom components which are distinct from the host OS components. The creation of the VM-container guest OS image from the host components, optionally dynamically upon start of the container, improves security of the host OS and/or the applications running within the container on the VM, for example, running the container created from the VM-container guest OS image separates the host kernel from the container running inside guest VM, reducing the risk of exploitation of the host kernel, by confining the attacking malicious entity inside the guest VM, without the ability to access the host computing device even after a successful exploitation attempt. Moreover, hypervisor-based containers created from the VM-container guest OS image enable a reduced attack surface since the guest machine includes the minimal set of components that are needed for starting and running the container, so even during a container escape event, there are limited tools available for the attacking malicious entity to utilize on the guest host.

The creation of the VM-container guest OS image from the host components, optionally dynamically upon start of the container(s) improves stability of the host OS and/or the applications running within the container on the VM, for example, a kernel has limited resources for network stack management (e.g., TCP handles) which when exhausted may lead to connectivity and network problems. The containers running inside VM created from the VM-container guest OS image is practically separated from the guest VM, reducing the risk of resource exhaustion.

Another technical problem addressed by the systems, methods, and/or code instructions described herein relates to removing the requirement to update the host OS and guest OS images separately, because once the host OS components are updated (manually and/or automatically), the VM-container guest OS image is automatically updated. The technical problem is addressed and/or the computational efficiency of the host computing device is further improved by improving the process that automatically and independently performs updating of the host kernel and/or host usermode components by the host computing device, sometimes referred to as compliance. For example, the computational burden of testing, integrating, and/or approving third party created critical components, such as the custom VM kernel, is reduced by the automatic update process performed by the host computing device.

In a further implementation form of the first, second, and third aspects, the method further comprises and/or the system includes code for and/or the computer program product includes additional instructions for monitoring for the modification of at least one of the following components: (i) the host kernel image, (ii) at least one of the plurality of predefined kernel modules, and (iii) at least one of the plurality of host userspace application, and reassembling the VM-container guest OS image to include the at least one modified component.

In a further implementation form of the first, second, and third aspects, the monitoring is performed by at least one of: performing a periodic query of the host operating system package manager to detect an application update, and detecting an update of a version of the host kernel image during each reboot of the host computing device.

In a further implementation form of the first, second, and third aspects, the VM-container guest OS image is assembled dynamically upon execution of the container.

In a further implementation form of the first, second, and third aspects, each executed container is run within a single corresponding VM.

In a further implementation form of the first, second, and third aspects, the VM is run during execution of the container and the execution of the VM is terminated when execution of the container is terminated.

In a further implementation form of the first, second, and third aspects, the host kernel image, the plurality of predefined kernel modules, and the plurality of host userspace applications are based on the host operating system of the host computing device.

In a further implementation form of the first, second, and third aspects, a plurality of containers are each executed within a respective virtual machine according to a common source VM-container guest OS image.

In a further implementation form of the first, second, and third aspects, the method further comprises and/or the system includes code for and/or the computer program product includes additional instructions for executing code instructions to detect an indication of the host kernel image of the host operating system.

In a further implementation form of the first, second, and third aspects, the method further comprises and/or the system includes code for and/or the computer program product includes additional instructions for determining, according to a predefined set of required host kernel modules, whether at least one of the plurality of predefined host kernel modules is locally unavailable on a local storage device of the host computing device.

In a further implementation form of the first, second, and third aspects, the set of required host kernel modules implement one or more of the following functionalities: network, disk, file system, and host to virtual machine file sharing.

In a further implementation form of the first, second, and third aspects, the method further comprises and/or the system includes code for and/or the computer program product includes additional instructions for, when at least one of the plurality of predefined host kernel modules is locally unavailable, obtaining the locally unavailable at least one predefined host kernel module from a remote server over a network.

In a further implementation form of the first, second, and third aspects, the method further comprises and/or the system includes code for and/or the computer program product includes additional instructions for compiling a source code implementation of the locally unavailable at least one predefined host kernel module obtained from the remote server into a loadable host kernel module locally stored on the local storage device of the host computing device.

In a further implementation form of the first, second, and third aspects, the locally unavailable at least one predefined host kernel module is automatically downloaded from the remote server over the network based on a member selected from the group consisting of: package manager, operating system control server, and ftp/http server.

In a further implementation form of the first, second, and third aspects, the method further comprises and/or the system includes code for and/or the computer program product includes additional instructions for determining, according to a predefined set of required host userspace applications, whether at least one of the plurality of predefined host userspace application is locally unavailable on a local storage device of the host computing device.

In a further implementation form of the first, second, and third aspects, the plurality of predefined host userspace applications are selected from the group consisting of: basic shell, mountutils, udev utilities, network configuration utilities, kernel modutils, and standard runC for container runtime.

In a further implementation form of the first, second, and third aspects, the method further comprises and/or the system includes code for and/or the computer program product includes additional instructions for automatically installing the at least one unavailable predefined host userspace application on the host computing device.

In a further implementation form of the first, second, and third aspects, the assembled VM-container guest OS image is implemented as an initramfs image when the host operating system is implemented as Linux.

In a further implementation form of the first, second, and third aspects, the assembling the VM-container guest OS image is performed by: creating a temporary directory according to a standard filesystem layout defined by the host operating system, mirroring the (ii) plurality of predefined kernel modules and the (iii) plurality of host userspace applications, of the host OS to the created temporary directory, copying hardware, network, and filesystem OS initialization scripts from the host computing device, copying code instructions that execute the container within the virtual machine based on the host kernel of the host operating system, and assembling the contents stored in the temporary directory into the VM-container guest OS image.

In a further implementation form of the first, second, and third aspects, the container code instructions include instructions to implement one or more of the following acts when executed by one or more processors: configure virtual machine network adapter, mount root container file system to be accessible by components running inside the virtual machine, and execute standard container runtime within the virtual machine to start running of the actual container.

In a further implementation form of the first, second, and third aspects, the container code instructions are agnostic to the version and the implementation of the plurality of host userspace applications, agnostic to the host kernel image, and agnostic to the plurality of predefined kernel modules.

In a further implementation form of the first, second, and third aspects, the executing the container within the virtual machine based on the assembled VM-container guest OS image is performed by executing a hypervisor in the network namespace of the container by adding as parameters a path to the host kernel image, a path to the assembled VM-container guest OS image, and a path to a storage device storing a container rootfs, and when the virtual machine completes a boot process, the container code instructions in the assembled virtual machine container operating system image setup a virtual environment and execute code instructions that run the container.

In a further implementation form of the first, second, and third aspects, the method further comprises and/or the system includes code for and/or the computer program product includes additional instructions for reassembling the virtual machine container operating system when at least one of the following is detected: new version of the code instructions that run the container, a modified version of the code instructions that run the container, and a general system update.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below.

In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of assembling a VM-container guest OS image that executes one or more containers within each VM based on components of a host OS of a host computing device, in accordance with some embodiments of the present invention; and

FIG. 2 is a schematic of components of a system for assembling a VM-container guest OS image for executing container(s) within VM(s) based on components of a host OS of a host computing device, in accordance with some embodiments of the present invention.

### DESCRIPTION OF SPECIFIC EMBODIMENTS OF THE INVENTION

The present invention, in some embodiments thereof, relates to virtualization and, more specifically, but not exclusively, to hypervisor-based containers.

An aspect of some embodiments of the present invention relates to systems, methods, and/or code instructions (stored in a data storage device, executable by processor(s)) for assembling a virtual machine (VM) container guest operating system (OS) image based on components of a host OS running on a host computing device. Hypervisor-based containers are created and executed during runtime according to the assembled VM container OS image. The VM-container guest OS image is assembled based on the components of the host OS that are locally stored on the host computing device. Optionally, the VM-container guest OS image is assembled dynamically upon start of the container or after the updated components were introduced to the host OS. Moreover, in contrast to standard methods, in which VM images are created off-host (i.e., by an external computing device) from other arbitrary components. Such VM images are created in advance of start of the container, and the creation of the VM image is not dynamically performed and triggered by the start of the container. Each VM running a container therein (optionally a single container within a single VM) does not share kernel(s) with other similar VM-container instances, and does not share host OS kernel(s). Each VM running a container therein shares a common source VM-container guest OS image. However, when the VM is started from the VM-container guest OS image, processing within the VM are unique to the VM, and different from other similar VMs that were started from the common VM-container guest OS image.

The VM-container guest OS image is assembled based on the following host components:
(i) A kernel image of the host operating system hosting the virtual machine.
(ii) Predefined kernel modules of the host operating system that support virtualized hardware on the host computing device, the predefined kernel modules are defined according to the host kernel image.
(iii) Host userspace applications for executing the container within the VM running on the host hypervisor.
(iv) Container code instructions that set-up the virtual machine and/or the assembled VM-container guest OS image, for running the container within the virtual machine. The container code instructions are optionally agnostic to the version and the implementation of the host userspace applications, and/or agnostic to the host kernel image, and/or agnostic to the predefined host kernel modules.

Optionally, monitoring (e.g., of the host computing device) is performed to detect modification of one or more of the host components (i)-(iii). When a change and/or a new version of one or more of the host components is detected, the VM-container guest OS image is reassembled to include the modified component.

The host components, including the host kernel image, the predefined host kernel modules, and the host userspace applications, are based on the host operating system components running on the host computing device.

The systems and/or methods and/or code instructions described herein improve an underlying process within the technical field of hypervisor-based containers.

The systems, methods, and/or code instructions described herein address the technical problem(s) that arise when hypervisor-based containers are implemented. The addressed technical problem is related to security, optionally network security, in particular, to the problem of container escape and tenancy separation.

Moreover, existing hypervisor-based container runtime environments generally based on guest OS image which includes custom kernel and custom usermode components that execute the VM and run the container within the VM. Such guest OS components are distinct from the host OS executing on the host computing device on which the hypervisor is executing. The customized kernel and/or customized usermode components of the guest OS image, which are independent/different of/from the host OS running on the computing device, may be created by a third party entity, which is external and independent to the entity managing the host computing device on which the hypervisor is executed. The customized kernel and/or customized usermode components may present a security risk, and/or may be frequently updated, for example to correct errors, add new features, and fix security risks. The technical problem that arises is related to the overhead incurred during updating of the custom kernel and usermode components. Generally, the runtime external third party vendor performs the update of the custom kernel and customer usermode components. Significant overhead is incurred, and/or a security risk is formed during the gap between when the third party performs the update, and when the update is implemented within the host computing system.

The systems, methods, and/or code instructions described herein improve computational performance of the host computing device executing hypervisor-based containers. The computational performance of the host computing device is improved by the systems, methods, and/or code instructions described herein for assembling the VM-container guest OS image based on the host OS components, rather than based on custom OS components and/or other custom components which are distinct from the host OS components. The creation of the VM-container guest OS image from the host components, optionally dynamically upon start of the container, improves security of the host OS and/or the applications running within the container on the VM, for example, running the container created from the VM-container guest OS image separates the host kernel from the container running inside guest VM, reducing the risk of exploitation of the host kernel, by confining the attacking malicious entity inside the guest VM, without the ability to access the host computing device even after a successful exploitation attempt. Moreover, hypervisor-based containers created from the VM-container guest OS image enable a reduced attack surface since the guest machine includes the minimal set of components that are needed for starting and running the container, so even during a container escape event, there are limited tools available for the attacking malicious entity to utilize on the guest host.

The creation of the VM-container guest OS image from the host components, optionally dynamically upon start of the container(s) improves stability of the host OS and/or the applications running within the container on the VM, for example, a kernel has limited resources for network stack management (e.g., TCP handles) which when exhausted may lead to connectivity and network problems. The containers running inside VM created from the VM-container guest OS image is practically separated from the guest VM, reducing the risk of resource exhaustion.

Another technical problem addressed by the systems, methods, and/or code instructions described herein relates to removing the requirement to update the host OS and guest OS images separately, because once the host OS components are updated (manually and/or automatically), the VM-container guest OS image is automatically updated. The technical problem is addressed and/or the computational efficiency of the host computing device is further improved by improving the process that automatically and independently performs updating of the host kernel and/or host usermode components by the host computing device, sometimes referred to as compliance. For example, the computational burden of testing, integrating, and/or approving third party created critical components, such as the custom VM kernel, is reduced by the automatic update process performed by the host computing device.

The systems and/or methods and/or code instructions described herein do not simply describe the assembly of the VM-container guest OS image and receiving and storing data, but combine the acts of obtaining host kernel module(s) that are not locally stored, obtaining missing host userspace application(s) that are not locally stored, assembling the VM-container guest OS image based on the host components by code instructions of the container (stored in a data storage device executable by one or more processors), executing the container within the VM based on the assembled guest OS image, and monitoring (e.g., the host computing system) for changes to the host OS components. By this, the systems and/or methods and/or code instructions stored in a storage device executed by one or more processors described here go beyond the mere concept of simply retrieving and combining data using a computer.

The systems and/or methods and/or code instructions described herein are tied to physical real-life components, including one or more of: physical user interfaces (e.g., display), a data storage device, a hardware processor(s) that executes code instructions, and networking infrastructure.

Accordingly, the systems and/or methods and/or code instructions described herein are inextricably tied to computing technology and/or physical components to overcome an actual technical problem arising in implementation of hypervisor-based containers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

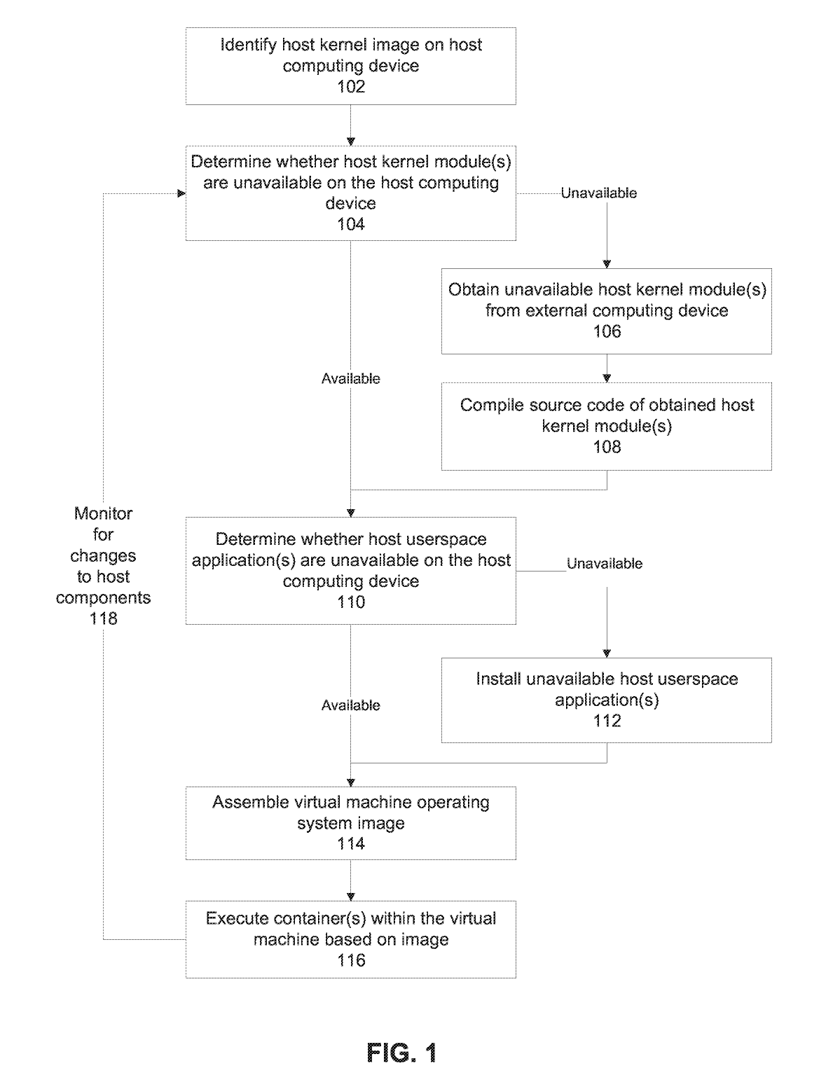

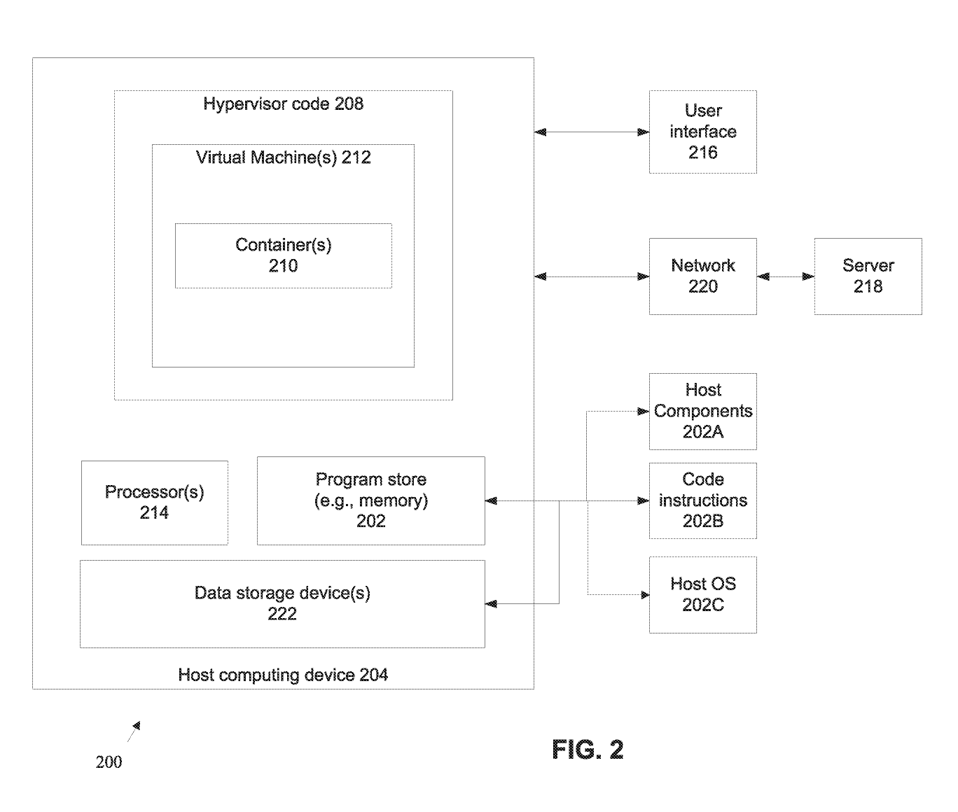

Reference is now made to FIG. 1, which is a flowchart of a method of assembling a VM-container guest OS image (e.g., initramfs image when the host OS is based on Linux) that is the base for execution of one or more containers within each VM, based on components of a host OS of a host computing device, in accordance with some embodiments of the present invention. The reused host components (e.g., code instructions, files, libraries, compiled code, non-compiled code, script) of host OS running on the host computing device are in contrast to components created by another computing device from other arbitrary components by an entity that does manage the host computing. Reference is also made to FIG. 2, which is a schematic of components of a system 200 for assembling a VM-container guest OS image 206 for executing container(s) 210 within VM(s) 212 running on a hypervisor 208, based on host components (e.g., stored as code instructions) 202A of a host OS 202C running on a host computing device 204, in accordance with some embodiments of the present invention. Optionally, each container 210 is run within a single corresponding VM 212. Optionally, VM 212 is run during execution of container 210 and execution of VM 212 is terminated upon termination of execution of container 210.

Host computing device 204 may be implemented as, for example, one or more of: a single computing device (e.g., client terminal), a group of computing devices arranged in parallel, a computing cloud, a network server, a local server, a remote server, a client terminal, a mobile device, a stationary device, a kiosk, a smartphone, a laptop, a tablet computer, a wearable computing device, a glasses computing device, a watch computing device, and a desktop computer.

Host computing device 204 includes one or more processor(s) 214, implemented as for example, central processing unit(s) (CPU), graphics processing unit(s) (GPU), field programmable gate array(s) (FPGA), digital signal processor(s) (DSP), application specific integrated circuit(s) (ASIC), customized circuit(s), processors for interfacing with other units, and/or specialized hardware accelerators. Processor(s) 214 may be implemented as a single processor, a multi-core processor, and/or a cluster of processors arranged for parallel processing (which may include homogenous and/or heterogeneous processor architectures).

Program store 202 (may also be referred to as memory, or data storage device) stores code instructions implementable by processor(s) 214. Program store 202 is implemented as, for example, a random access memory (RAM), read-only memory (ROM), and/or a storage device, for example, non-volatile memory, magnetic media, semiconductor memory devices, hard drive, removable storage, and optical media (e.g., DVD, CD-ROM).

Program store 202 stores hypervisor code 208 that runs one or more VMs 212, which may each execute one or more containers 210. Each container 210 may execute one or more applications, for example, a web server, and a file server.

Program store 202 may store one or more of: host components 202A, code instructions 202B, and/or host OS 202C (e.g., Linux), as described herein.

Computing device 204 may be in communication with a user interface 216 that presents data and/or includes a mechanism for entry of data, for example, one or more of: a touch-screen, a display, a keyboard, a mouse, voice activated software, and a microphone.

Computing device 204 is in communication with one or more servers 218 over a network 220, for example, OS distribution servers that store updates of components of the host OS 202C running on computing device 204.

Computing device 204 may include a data storage device 222 that stores one or more of: host components 202A, code instructions 202B, and host OS 202C. It is noted that code instructions may be selectively loaded from data storage device 222 into memory 202 for execution by processor(s) 214. Data storage device 222 may be implemented as, for example, a memory, a local hard-drive, a removable storage unit, an optical disk, a storage device, and/or as a remote server and/or computing cloud (e.g., accessed via a network connection). It is noted that as described herein, the term locally stored means stored in association with computing device 204, which may include remotely located storage device(s) that are accessed by computing device 204. The term local storage device includes local and remotely located implementations of data storage device 222.

Program store 202 stores code instructions 202B that implement one or more of the acts of the method described with reference to FIG. 1 when executed by processor(s) 214. Code instructions 202B include instructions for assembling the VM-container guest OS image based on host components 202A. Code instructions 202B include code constructions for setting-up the virtual machine and/or the assembled VM-container guest OS image for running of the container within the virtual machine.

Referring now back to FIG. 1, at 102, an indication of the host kernel image (e.g., stored as host components 202A) of host OS 202C currently running on host computing device 204 is detected.

Exemplary methods of detecting the indication of the host kernel image when the host OS 202C is based on Linux include:
Reading the kernel cmdline from /proc/cmdline, and identifying the BOOT_IMAGE parameter.
Reading the kernel version from /proc/version, and identifying the corresponding image in the /boot folder.

The following exemplary data may be extracted based on the identified host kernel image: OS release, OS version, machine type (e.g., x86, x64).

At 104, an analysis is performed to determine whether one or more host kernel modules (i.e., host components 202A based on host OS 202C) are unavailable on host computing device 204, for example, not stored on data storage device 222.

The set of host kernel modules that support virtualized hardware (e.g., devices based on the Virtio virtualization standard) may be a predefined set of required host kernel modules, optionally according to the host kernel image. The predefined host kernel modules may be stored, for example, locally by host computing device 204 on data storage device 222, and/or remotely on a server accessed by host computing device 204.

The host kernel modules corresponding to the identified host kernel image are searched, for example, by analyzing the config file of the identified host kernel image.

Optionally, the following functionalities (e.g., stored as code instructions implemented by processor(s) 214) provided by host components 202A are searched for and analyzed to identify unavailable host components: network, disk, file system, and host computing device to VM file sharing. Exemplary host kernel modules that each perform a certain functionality include: xfs, ext4, virtio-net, and virtio-9p-net.

Alternatively or additionally, the current kernel configuration is identified, for example, at the distro dependent path (location depends on the distro implementation). The current kernel configuration is analyzed to identify unavailable host kernel modules based on identifying the status of the available functionalities. Each functionality (i.e., code instructions) may be identified as: compiled into a kernel, compiled as a loadable module, or not compiled (indicative of unavailability). The type of functionality may be identified based on an analysis of the kernel config file. For example, the functionality may be identified as not compiled based on an off flag in the kernel configuration.

When one or more functionalities (i.e., host kernel module code instructions) are unavailable on a local storage device (e.g., data storage device 222) of host computing device 204, acts 106-108 are executed, followed by act 110. Alternatively, when the functionalities (i.e., host kernel module code instructions) are available on a local storage device (e.g., data storage device 222) of host computing device 204, act 110 is executed.

At 106, the one or more functionalities (i.e., host kernel module code instructions) determined as unavailable are obtained, optionally from an external computing device such as a remote server, optionally over a network. Host computing device 204 may access OS distribution server 218 via network 220. OS distribution server 218 may provide kernel sources. The functionality (i.e., host kernel module code instructions) may be obtained, for example, as source code.

Other exemplary external source servers from which the missing functionalities may be obtained (e.g., downloaded) by host computing device 204 via network 220 include one or more of: package manager, OS source control server, and ftp/http server(s). The external source server may vary according to the implementation of distro.

At 108, when the functionality (i.e., host kernel module code instructions) obtained is in source code form, the functionality source code is compiled into a loadable host kernel module. The compiled loadable host kernel module is stored locally by host computing device 204, for example, in memory 202 and/or data storage device 222.

Optionally, a compiler programmed to compile the functionality source code into the host kernel module(s) is installed. The build dependencies of the functionality source code are installed. For example, gcc, make, autoconf, and the like. Kernel sources are prepared for module compilation, for example, by executing the make modules prepare command. The functionality (i.e., host kernel module code instructions) is compiled, for example, by executing make −M FUNCTIONALITY_PATH denoting a loadable module source code path.

At 110, an analysis is performed to determine whether one or more host userspace applications implemented for executing container(s) 210 in VM 212 are unavailable on host computing device 204.

The set of host userspace applications for preparing the environment for executing container(s) 210 in VM 212 and/or for the execution of container(s) 210 in VM 212 may be a predefined set of host userspace applications, optionally according to the host kernel image. The predefined host userspace applications may be stored, for example, locally by host computing device 204 on memory 202 and/or data storage device 222, and/or remotely on a server.

Exemplary host userspace applications implemented for executing container(s) 210 in VM 212 include: basic shell, mountutils, udev utilities, network configuration utilities, kernel modutils, and code instructions for executing containers (e.g., standard runc (container runtime)).

The presence or absence of each host userspace application may be identified, for example, with a package manager query functionality of a package manager application running on host computing device 204.

When one or more host userspace applications are unavailable on a local storage device (e.g., data storage device 222) of host computing device 204, act 112 is executed, followed by act 114. Alternatively, when the host userspace applications for executing container(s) 210 in VM 212 are available on a local storage device (e.g., data storage device 222) of host computing device 204, act 114 is executed.

At 112, the unavailable host userspace application is automatically installed on host computing device 204 (e.g., on storage device 222 and/or memory 202), for example, with the package manager.

At 114, the initial RAM file system (e.g., initramfs when the host OS is based on Linux) image (i.e., the VM OS image) is assembled based on the available and/or compiled host kernel modules (e.g., stored as host components 202A), based on the host userspace applications (e.g., auxiliary relevant userspace applications) (e.g., stored as host components 202A) and container code instructions 202B) which are optionally agnostic to one or more of: the version and/or implementation of the host userspace applications, the host kernel modules, and/or the host kernel image.

Container code instructions 202B include instructions for setting-up the virtual machine and/or setting-up the assembled virtual machine container image, for running of the container within the virtual machine. Code 202B includes instructions to implement one or more of the following acts when executed by one or more processors:
Configure VM network adapter.
Mount root container file system to be accessible by components running inside the VM.
Execute container runtime within the VM to start running of the actual container (e.g., standard runc).

An exemplary assembly process is now described for assembling the VM container OS image. A temporary directory is created according to the standard filesystem defined by the host OS. For example, based on a standard Linux filesystem layout. A portion of the host filesystem (i.e., the relevant modules and/or host userspace applications) are mirrored (e.g., copied) to the created temporary directory. Hardware initialization code instructions (e.g., scripts), network initialization code instructions (e.g., scripts), and/or filesystem initialization code instructions (e.g., scripts) are copied from the host computing device 204 to the created temporary directory. A portion of code instructions 202B that execute container(s) 210 within VM(s) 212 based on the kernel of host OS 202C are copied to the created temporary directory. The contents stored in the created temporary directory are converted into the image, for example, into the initramfs image using cpio tool.

At 116, container(s) 210 is executed within VM 212 based on the assembled VM container OS image. Optionally, block 114 is executed in response to execution of act 116, where the VM-container guest OS image is assembled dynamically upon start of execution of the container.

Optionally, each container 210 is run within a single corresponding VM 212. Optionally, VM 212 is run during execution of container 210 and execution of VM 212 is terminated upon termination of execution of container 210.

Hypervisor 208 is executed in the network namespace of container 210, by adding as parameters of hypervisor 208 the following: the path to the detected kernel image, the path to the assembled VM container OS image (e.g., initramfs image when the host OS is based on Linux), and the path to storage device (e.g., data storage device 222) storing the container rootfs.

When VM 212 completes the boot process, components of code 202B within the assembled VM container OS image (e.g., initramfs image) setup a virtual environment and execute code instructions (e.g., standard runc) that handle the actual execution of container 210.

At 118, host computing device 204 monitors for changes in one or more of: the host kernel image, one or more of the predefined host kernel modules, and one or more or of the host userspace applications used to create the VM container OS image. The monitoring may be performed by code instructions executing on host computing device 204 that monitor data stored on host computing device 204 to detect the changes.

Alternatively or additionally monitored changes include one or more of: new or modified kernel, new or modified version of the code instructions that run the container (e.g., runc), and general system update.

The monitoring may be performed as a periodic query triggered based on predefined time intervals, randomly, and/or defined events. The query may be executed by the OS package manager for application updates. The query may be executed in response to a detected reboot of an active kernel version, which may be detected as described with reference to act 102.

When one or more changes are detected, acts 104-116 are iterated to reassemble the VM container OS image to include the modified components.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant hypervisor-based containers will be developed and the scope of the term hypervisor-based container is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of creating a virtual machine (VM)-container guest operating system (OS) image for executing a container within a virtual machine started from above guest OS image, comprising:
assembling a VM-container guest OS image based on:
(i) a kernel image of a host OS currently running on a host computing device hosting the virtual machine,
(ii) a plurality of predefined kernel modules of the host OS that support virtualized hardware on the host computing device,
(iii) a plurality of host userspace applications for executing the container within the virtual machine, created from VM-container guest OS image, running on the host computing device, and
(iv) container code constructions that set-up at least one of the virtual machine and the assembled VM-container guest OS image, for running of the container within the virtual machine; and
executing the container within the virtual machine based on the assembled VM-container guest OS image.

2. The method according to claim 1, further comprising:
monitoring for the modification of at least one of the following components: (i) the host kernel image, (ii) at least one of the plurality of predefined kernel modules, and (iii) at least one of the plurality of host userspace application; and
reassembling the VM-container guest OS image to include the at least one modified component.

3. The method according to claim 2, wherein the monitoring is performed by at least one of: performing a periodic query of the host operating system package manager to detect an application update, and detecting an update of a version of the host kernel image during each reboot of the host computing device.

4. The method according to claim 1, wherein the VM-container guest OS image is assembled dynamically upon execution of the container.

5. The method according to claim 1, wherein each executed container is run within a single corresponding VM.

6. The method according to claim 1, wherein the VM is run during execution of the container and the execution of the VM is terminated when execution of the container is terminated.

7. The method according to claim 1, wherein the host kernel image, the plurality of predefined kernel modules, and the plurality of host userspace applications are based on the host operating system of the host computing device.

8. The method according to claim 1, wherein a plurality of containers are each executed within a respective virtual machine according to a common source VM-container guest OS image.

9. The method according to claim 1, further comprising: executing code instructions to detect an indication of the host kernel image of the host operating system.

10. The method according to claim 1, further comprising:
determining, according to a predefined set of required host kernel modules, whether at least one of the plurality of predefined host kernel modules is locally unavailable on a local storage device of the host computing device.

11. The method according to claim 10, wherein the set of required host kernel modules implement one or more of the following functionalities: network, disk, file system, and host to virtual machine file sharing.

12. The method according to claim 11, further comprising:
when at least one of the plurality of predefined host kernel modules is locally unavailable, obtaining the locally unavailable at least one predefined host kernel module from a remote server over a network.

13. The method according to claim 12, further comprising:
compiling a source code implementation of the locally unavailable at least one predefined host kernel module obtained from the remote server into a loadable host kernel module locally stored on the local storage device of the host computing device.

14. The method according to claim 12, wherein the locally unavailable at least one predefined host kernel module is automatically downloaded from the remote server over the network based on a member selected from the group consisting of: package manager, operating system control server, and ftp/http server.

15. The method according to claim 1, further comprising:
determining, according to a predefined set of required host userspace applications, whether at least one of the plurality of predefined host userspace application is locally unavailable on a local storage device of the host computing device.

16. The method according to claim 15, wherein the plurality of predefined host userspace applications are selected from the group consisting of: basic shell, mountutils, udev utilities, network configuration utilities, kernel modutils, and standard runC for container runtime.

17. The method according to claim 15, further comprising:
automatically installing the at least one unavailable predefined host userspace application on the host computing device.

18. The method according to claim 1, wherein the assembled VM-container guest OS image is implemented as an initramfs image when the host operating system is implemented as Linux.

19. The method of according to claim 1, wherein the assembling the VM-container guest OS image is performed by:
creating a temporary directory according to a standard filesystem layout defined by the host operating system;
mirroring the (ii) plurality of predefined kernel modules and the (iii) plurality of host userspace applications, of the host OS to the created temporary directory;
copying hardware, network, and filesystem OS initialization scripts from the host computing device;
copying code instructions that execute the container within the virtual machine based on the host kernel of the host operating system; and
assembling the contents stored in the temporary directory into the VM-container guest OS image.

20. The method according to claim 1, wherein the container code instructions include instructions to implement one or more of the following acts when executed by one or more processors: configure virtual machine network adapter, mount root container file system to be accessible by components running inside the virtual machine, and execute standard container runtime within the virtual machine to start running of the actual container.

21. The method according to claim 1, wherein the container code instructions are agnostic to the version and the implementation of the plurality of host userspace applications, agnostic to the host kernel image, and agnostic to the plurality of predefined kernel modules.

22. The method according to claim 1, wherein the executing the container within the virtual machine based on the assembled VM-container guest OS image is performed by executing a hypervisor in the network namespace of the container by adding as parameters a path to the host kernel image, a path to the assembled VM-container guest OS image, and a path to a storage device storing a container rootfs, and when the virtual machine completes a boot process, the container code instructions in the assembled virtual machine container operating system image setup a virtual environment and execute code instructions that run the container.

23. The method according to claim 1, further comprising reassembling the virtual machine container operating system when at least one of the following is detected: new version of the code instructions that run the container, a modified version of the code instructions that run the container, and a general system update.

24. A system for creating a virtual machine (VM)-container guest operating system (OS) image for executing a container within a virtual machine started from above guest OS image, comprising:
a non-transitory memory having stored thereon a code for execution by at least one hardware processor of a host computing device, the code comprising:
code for assembling a VM-container guest OS image based on: (i) a kernel image of a host OS currently running on a host computing device hosting the virtual machine, (ii) a plurality of predefined kernel modules of the host OS that support virtualized hardware on the host computing device, (iii) a plurality of host userspace applications for executing the container within the virtual machine, created from VM-container guest OS image, running on the host computing device, and (iv) container code constructions that set-up at least one of the virtual machine and the assembled VM-container guest OS image, for running of the container within the virtual machine; and
code for executing the container within the virtual machine based on the assembled VM-container guest OS image.

25. A computer program product for creating a virtual machine (VM)-container guest operating system (OS) image for executing a container within a virtual machine started from above guest OS image, comprising:
a non-transitory memory having stored thereon a code for execution by at least one hardware processor of a host computing device, the code comprising:
instructions for assembling a VM-container guest OS image based on: (i) a kernel image of a host OS currently running on a host computing device hosting the virtual machine, (ii) a plurality of predefined kernel modules of the host OS that support virtualized hardware on the host computing device, (iii) a plurality of host userspace applications for executing the container within the virtual machine, created from VM-container guest OS image, running on the host computing device, and (iv) container code constructions that set-up at least one of the virtual machine and the assembled VM-container guest OS image, for running of the container within the virtual machine; and
code for executing the container within the virtual machine based on the assembled VM-container guest OS image.
